(19) United States
(12) Patent Application Publication
(10) Pub. No.: US 2019/0120988 A1
(43) Pub. Date: Apr. 25, 2019

(54) TRIPLE-DEPTH QUAD-SOURCE SEISMIC ACQUISITION

(71) Applicant: PGS Geophysical AS, Oslo (NO)

(72) Inventor: David O'DOWD, Oslo (NO)

(21) Appl. No.: 16/148,443

(22) Filed: Oct. 1, 2018

Related U.S. Application Data
(60) Provisional application No. 62/575,662, filed on Oct. 23, 2017.

(51) Int. Cl. G01V 1/38

(52) U.S. Cl. CPC G01V 1/3826; G01V 1/3861; B63B 21/66; G01V 2210/56; G01V 1/3808

(57) ABSTRACT

An apparatus for marine seismic surveying includes four seismic sources, each comprising three independent source subarrays, wherein, for each source: each subarray is configured to be towed at a different one of three selected depths, each subarray has a same total volume, and each subarray comprises a same number of source elements; wherein the four sources share the three independent subarrays such that the source array consists of six subarrays. A method for marine seismic surveying includes towing six source subarrays with a survey vessel; and sequentially actuating four sets of three of the six subarrays to generate a source signal with each actuation, wherein, for each of the four sets, the three of the six subarrays: are towed at three different selected depths, have a same total volume, and comprise a same number of source elements.

### CROSS REFERENCE TO RELATED APPLICATIONS

This application claims benefit of U.S. Provisional Patent Application Ser. No. 62/575,662, filed Oct. 23, 2017, entitled “Multi-Level Source for Quad Source Acquisition Geometries,” which is incorporated herein by reference.

### BACKGROUND

This disclosure is related generally to the field of marine surveying. Marine surveying can include, for example, seismic and/or electromagnetic surveying, among others. For example, this disclosure may have applications in marine surveying in which one or more sources are used to generate energy (e.g., wavefields, pulses, signals), and geophysical sensors—either towed or ocean bottom—receive energy generated by the sources and possibly affected by interaction with subsurface formations. Geophysical sensors may be towed on cables referred to as streamers. Some marine surveys locate geophysical sensors on ocean bottom cables or nodes in addition to, or instead of, streamers. The geophysical sensors thereby collect survey data which can be useful in the discovery and/or extraction of hydrocarbons from subsurface formations.

Many marine surveys utilize one or more seismic sources—typically air guns. Air guns in arrays are typically towed at the same depth and fired at the same time to generate a powerful seismic signal. Some air gun arrays are divided into two equal subarrays and fired in a flip-flop sequence, at least in part to allow for more closely-spaced shots (e.g., the first subarray resets while the second subarray fires).

Acquiring seismic data with conventional air gun sources presents a number of challenges. Mid-survey failure is common and often difficult to detect. Destructive interference is known to cause a source “ghost” in the signal. There may be limitations to the number of air guns any one vessel may tow—due to power and air requirements and/or to drag effects. However, operating additional vessels may be prohibitively expensive. More reliable and efficient seismic sources would be beneficial.

### BRIEF DESCRIPTION OF THE DRAWINGS

So that the manner in which the features of the present disclosure can be understood in detail, a more particular description of the disclosure may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1A illustrates an exemplary marine seismic survey with a dual-source setup. FIG. 1B illustrates an exemplary marine seismic survey with a triple-source setup.

FIGS. 2A-2D illustrate exemplary seismic sources suitable for Triple-Depth Quad-Source (“TDQS”) seismic acquisition. FIG. 2E illustrates an exemplary TDQS source array.

FIG. 3A illustrates an exemplary pressure signal from a conventional source array. FIG. 3B illustrates an exemplary pressure signal from a TDQS source array.

FIG. 4A illustrates an exemplary amplitude spectrum for a conventional source array. FIG. 4B illustrates an exemplary amplitude spectrum for a TDQS source array.

FIG. 5 illustrates an exemplary TDQS survey system.

### DETAILED DESCRIPTION

It is to be understood the present disclosure is not limited to particular devices or methods, which may, of course, vary. It is also to be understood that the terminology used herein is for the purpose of describing particular embodiments only, and is not intended to be limiting. As used herein, the singular forms “a”, “an”, and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.” The term “coupled” means directly or indirectly connected. The word “exemplary” is used herein to mean “serving as an example, instance, or illustration.” Any aspect described herein as “exemplary” is not necessarily to be construed as preferred or advantageous over other aspects. The term “uniform” means substantially equal for each sub-element, within about +−10% variation. The term “nominal” means as planned or designed in the absence of variables such as wind, waves, currents, or other unplanned phenomena. “Nominal” may be implied as commonly used in the field of marine surveying.

“Cable” shall mean a flexible, axial load carrying member that also comprises electrical conductors and/or optical conductors for carrying electrical power and/or signals between components.

“Rope” shall mean a flexible, axial load carrying member that does not include electrical and/or optical conductors. Such a rope may be made from fiber, steel, other high strength material, chain, or combinations of such materials.

“Line” shall mean either a rope or a cable.

“Forward” or “front” shall mean the direction or end of an object or system that corresponds to the intended primary direction of travel of the object or system.

“Aft” or “back” shall mean the direction or end of an object or system that corresponds to the reverse of the intended primary direction of travel of the object or system.

“Port” and “starboard” shall mean the left and right, respectively, direction or end of an object or system when facing in the intended primary direction of travel of the object or system.

The term “simultaneous” does not necessarily mean that two or more events occur at precisely the same time or over exactly the same time period. Rather, as used herein, “simultaneous” means that the two or more events occur near in time or during overlapping time periods. For example, the two or more events may be separated by a short time interval that is small compared to the duration of the surveying operation. As another example, the two or more events may occur during time periods that overlap by about 40% to about 100% of either period.

If there is any conflict in the usages of a word or term in this specification and one or more patent or other documents that may be incorporated herein by reference, the definitions that are consistent with this specification should be adopted for the purposes of understanding this disclosure.

The present disclosure generally relates to marine seismic survey methods and apparatuses, and, at least in some embodiments, to novel seismic sources, and their associated methods of use.

Acquiring seismic data with conventional air gun sources presents a number of challenges. Mid-survey failure is common and often difficult to detect. Destructive interference is known to cause a source “ghost” in the signal. There may be limitations to the number of air guns any one vessel may tow—due to power and air requirements and/or to drag effects. However, operating additional vessels may be prohibitively expensive. More reliable and efficient seismic sources would be beneficial.

One of the many potential advantages of the embodiments of the present disclosure, is that, at least in some embodiments, spare air guns and/or air gun arrays are included for resilience and redundancy. Another potential advantage includes air gun configurations that reduce, minimize, or eliminate source ghost effects. Another potential advantage includes a system that balances the competing costs of flexibility, redundancy, source power, equipment weight, equipment maintenance, and drag. Embodiments of the present disclosure can thereby be useful in the discovery and/or extraction of hydrocarbons from subsurface formations.

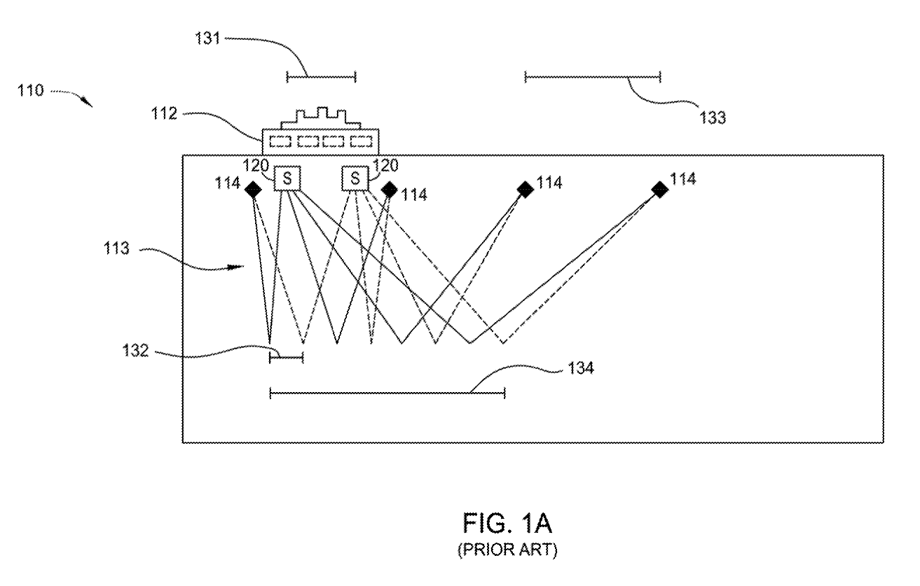

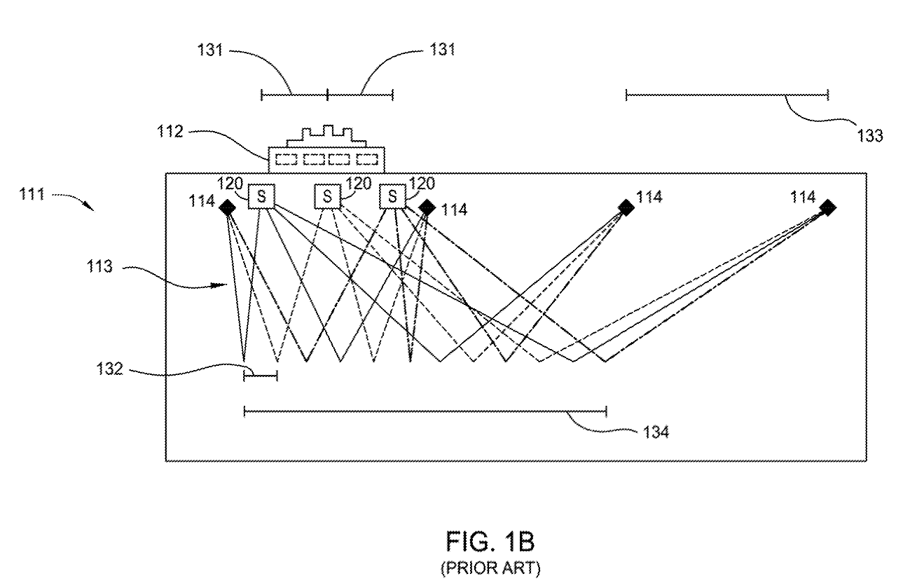

Many marine seismic surveys deploy a dual-source setup 110, as illustrated in FIG. 1A. Dual-source setup 110 has two independently-activated seismic sources 120 towed by a single survey vessel 112 at a crossline source separation 131. Some marine seismic surveys deploy a triple-source setup 111, as illustrated in FIG. 1B. Triple-source setup 111 has three independently-activated seismic sources 120 towed by a single survey vessel 112 at crossline source separations 131. Each of FIGS. 1A and 1B is a functional diagram, essentially looking from the tail of the streamers 114 (which have receivers thereon) towards the stern of the survey vessels 112. FIGS. 1A and 1B show ray paths 113 between the seismic sources 120 and streamers 114. As illustrated, the dual-source setup 110 and the triple-source setup 111 each have the same crossline source separation 131 (though the triple-source setup 111 has twice that distance between the port-most seismic source and the starboard-most seismic source). As illustrated, the dual-source setup 110 and the triple-source setup 111 each have the same crossline bin width 132. As illustrated, the triple-source setup 111 has a 50% larger crossline streamer separation 133 and crossline subsurface illumination 134 than the dual-source setup 110. Hence, a triple-source setup 111 can provide greater crossline streamer separation and greater acquisition efficiency (e.g., fewer passes to cover the same acquisition footprint) than a dual-source setup 110. Alternatively, a triple-source setup 111 with the same crossline streamer separation 133 as a dual-source setup 110 would have a tighter crossline bin width 132. Hence, a triple-source setup can provide better spatial crossline sampling than a dual-source setup, and thereby provide images with improved spatial resolution. Similarly, with tighter crossline bin widths 132, a triple-source setup may have less aliasing noise, and can thereby acquire higher frequency seismic data than a dual-source setup.

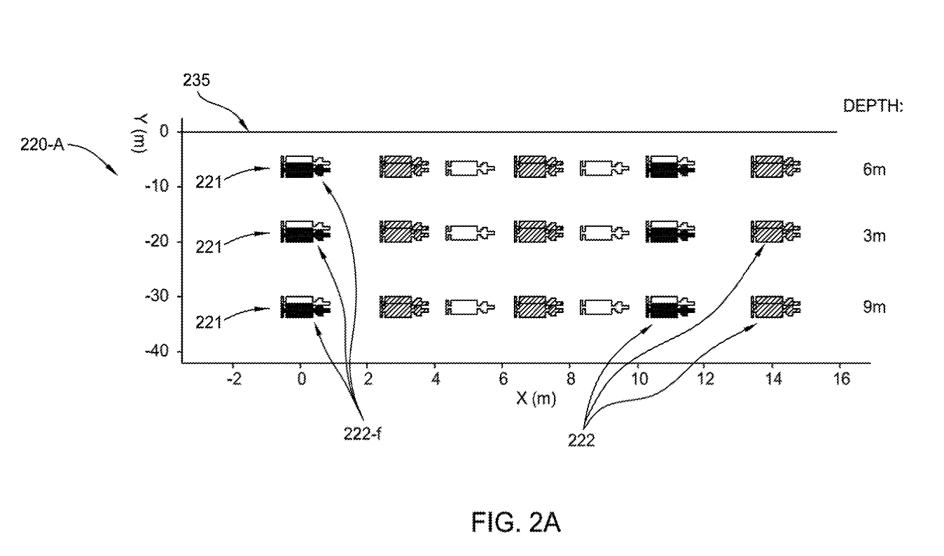

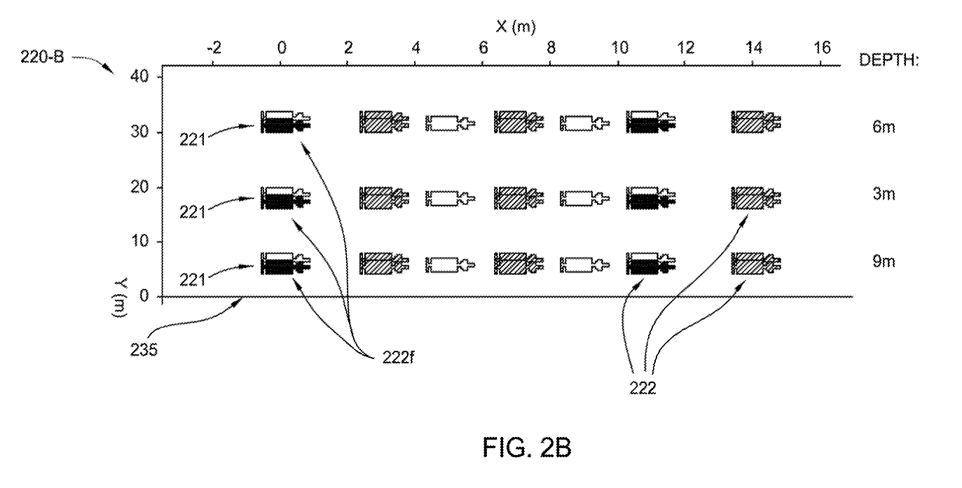

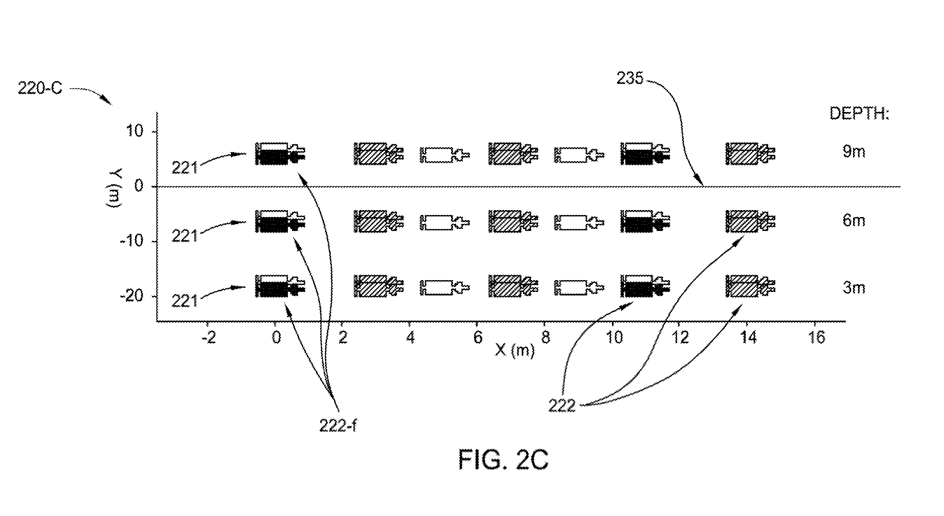

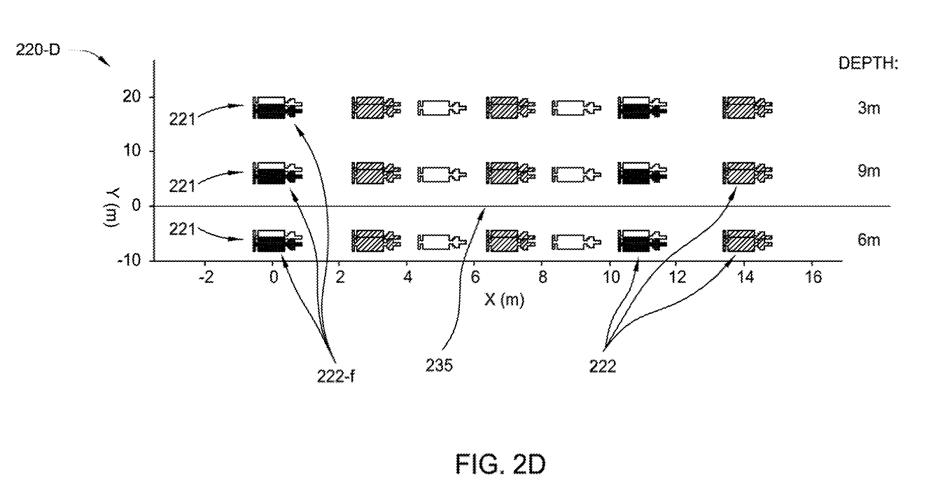

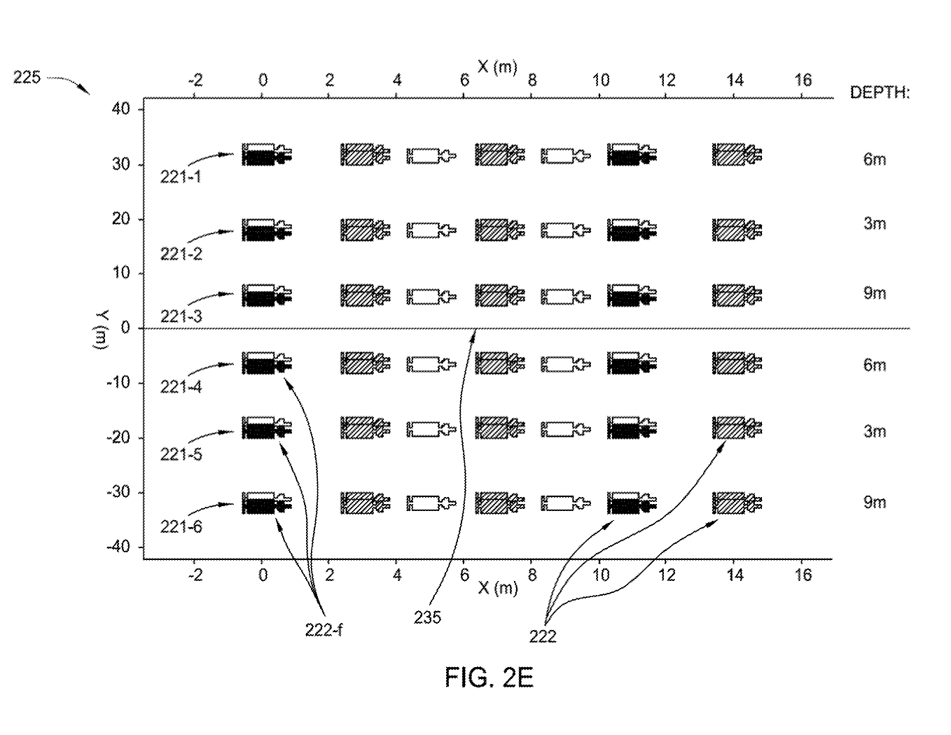

Each seismic source 120 may be an array of source elements (e.g., a single air gun or a collection of air guns) or a collection of arrays of source elements configured to be actuated simultaneously, near-simultaneously, or in a defined sequence. Multiple source elements may provide redundancy, flexibility, and cost savings (compared to a single, large source element). For example, FIG. 2A illustrates an exemplary seismic source 220-A suitable for Triple-Depth Quad-Source (“TDQS”) seismic acquisition. FIG. 2A illustrates a view from above, wherein the left side of the figure is forward (closer to the survey vessel (not shown)), the right side of the figure is aft (closer to the streamers (not shown)), the top of the figure is the midline 235 of the path of the survey vessel, and the bottom of the figure is port of the midline 235. The y-axis measures distance from midline 235, while the x-axis measures distance from the forward-most source elements 222-f. Seismic source 220-A includes three source subarrays 221, each having seven source elements 222 (not all labeled). In some embodiments, each of the source elements 222 of a given source subarray 221 will be connected together on the same source cable (not shown). In some embodiments, for each of the six source subarrays, the source elements are disposed at seven different inline positions along a common source cable. A single source cable may then be used to provide air, power, and signal communication for each of the source elements 222 of a single source subarray 221. As illustrated, each source subarray 221 is deployed at a different depth: about 9 m for the port-most source subarray 221, about 3 m for the middle source subarray 221, and about 6 m for the starboard-most source subarray 221. A variety of mechanisms and methods are known and may be used to tow the source subarrays 221 at the selected depths. As illustrated, each source subarray 221 is deployed at a different distance from the midline 235: about 31.25 m for the port-most source subarray 221, about 18.75 m for the middle source subarray 221, and about 6.25 m for the starboard-most source subarray 221. A variety of mechanisms and methods are known and may be used to tow the source subarrays 221 at the selected crossline positions. As illustrated, the source elements 222 are deployed at different distances from the forward-most source element 222-f: about 3 m, about 5 m, about 7 m, about 9 m, about 11 m, and about 14 m. A variety of mechanisms and methods are known and may be used to tow the source elements 222 at the selected inline positions. In some embodiments, the source elements 222 of each source subarray 221 are configured to be actuated simultaneously, near-simultaneously, or in a defined sequence. In some embodiments, the source subarrays 221 of seismic source 220-A are configured to be actuated simultaneously, near-simultaneously, or in a defined sequence.

Each of the source elements 222 in seismic source 220-A may be made of one or more air guns, have a different volume, and serve a different function for the seismic source 220-A. For example, the source elements 222 at the 0 m, about 3 m, about 7 m, and about 14 m inline positions may each include a pair of air guns, while the source elements 222 at the about 5 m and about 9 m inline positions may each include only a single air gun. As another example, each of the air guns in the various source elements 222 may have a different volume. For example, each of the air guns of the source elements 222 at the 0 m and about 3 m inline positions may have a volume of about 60 cu in., each of the air guns at the about 5 m inline positions may have a volume of about 70 cu in., each of the air guns of the source elements 222 at the about 7 m and the about 11 m inline positions may have a volume of about 250 cu in., each of the air guns at the about 9 m inline positions may have a volume of about 40 cu in., and each of the air guns of the source elements 222 at the about 14 m inline positions may have a volume of about 90 cu in. As another example, one of the air guns of the forward-most source elements 222-f may be designated to be “spare”, to be fired when another source element 222 fails or in other selected circumstances. Spare air guns may provide additional redundancy and/or flexibility for the source subarray 221. As another example, one of the air guns of the source elements 222 at the about 11 m inline position may be designated to be spare. In some embodiments, the volumes of the source elements 222 of each source subarray 221 may be selected to add together so that each source subarray 221 has the same total volume. For example, each source subarray 221 may have a total volume of about 1220 cu in. (without including the volumes of the spare air guns). Consequently, seismic source 220-A has a total volume of about 3660 cu in.

FIG. 2B illustrates another exemplary seismic source 220-B suitable for TDQS seismic acquisition. As illustrated Seismic source 220-B is configured substantially similarly to seismic source 220-A. A notable difference is that FIG. 2B illustrates a view wherein the bottom of the figure is the midline 235 of the path of the survey vessel, and the top of the figure is starboard of the midline 235. As illustrated, each source subarray 221 is deployed at a different distance from the midline 235: about 31.25 m for the starboard-most source subarray 221, about 18.75 m for the middle source subarray 221, and about 6.25 m for the port-most source subarray 221.

FIG. 2C illustrates another exemplary seismic source 220-C suitable for TDQS seismic acquisition. As illustrated Seismic source 220-C is configured substantially similarly to seismic sources 220-A and 220-B. A notable difference is that FIG. 2C illustrates a seismic source 220-C straddling the midline 235 of the path of the survey vessel. The two source subarrays 221 near the bottom of the figure are port of the midline 235, and the source subarray 221 near the top of the figure is starboard of the midline 235. As illustrated, each source subarray 221 is deployed at a different distance from the midline 235: about 18.75 m portward for the port-most source subarray 221, about 6.25 m portward for the middle source subarray 221, and about 6.25 m starboardward for the starboard-most source subarray 221. As illustrated, each source subarray 221 is deployed at a different depth: about 3 m for the port-most source subarray 221, about 6 m for the middle source subarray 221, and about 9 m for the starboard-most source subarray 221.

FIG. 2D illustrates another exemplary seismic source 220-D suitable for TDQS seismic acquisition. As illustrated Seismic source 220-D is configured substantially similarly to seismic sources 220-A, 220-B, and 220-C. A notable difference is that FIG. 2D illustrates a seismic source 220-D straddling the midline 235 of the path of the survey vessel. The two source subarrays 221 near the top of the figure are starboard of the midline 235, and the source subarray 221 near the bottom of the figure is port of the midline 235. As illustrated, each source subarray 221 is deployed at a different distance from the midline 235: about 18.75 m starboardward for the starboard-most source subarray 221, about 6.25 m starboardward for the middle source subarray 221, and about 6.25 m portward for the port-most source subarray 221. As illustrated, each source subarray 221 is deployed at a different depth: about 6 m for the port-most source subarray 221, about 9 m for the middle source subarray 221, and about 3 m for the starboard-most source subarray 221.

A person of ordinary skill in the art with the benefit of this disclosure will appreciate that seismic sources 220-A, 220-B, 220-C, and 220-D may be synthesized by a collection of six independent source subarrays 221, as illustrated by the exemplary TDQS source array 225 in FIG. 2E. Seismic source 220-A includes independent source subarrays 221-4, 221-5, and 221-6. Seismic source 220-B includes independent source subarrays 221-1, 221-2, and 221-3. Seismic source 220-C includes independent source subarrays 221-3, 221-4, and 221-5. Seismic source 220-D includes independent source subarrays 221-2, 221-3, and 221-4. Consequently, TDQS source array 225 includes four seismic sources 220-A, 220-B, 220-C, and 220-D, each having three source subarrays 221 at three different depths. Actuation of any one of the four seismic sources 220-A, 220-B, 220-C, and 220-D results in actuation of the three respective source subarrays 221 simultaneously, near-simultaneously, or in a defined sequence. All of the six independent source subarrays 221 may be towed by a single survey vessel.

A person of ordinary skill in the art with the benefit of this disclosure will appreciate that a TDQS source array may be configured with several variations to the parameters illustrated by TDQS source array 225. For example, although the total volumes of the six source subarrays 221 should be substantially equal, the total volume of each source subarray 221 may be more or less than about 1220 cu in. Substantially equal volumes for the six source subarrays 221 may allow for the three signals of each of the seismic sources 220 to be very similar, if not nearly identical. Manufacturing and operational circumstances and desired outcomes of the survey may dictate preferred ranges of total subarray volumes. Similarly, although the total volumes of the six source subarrays 221 should be substantially equal, and the volume of each source element 222 at like distances from the forward-most source element 222-f should be substantially equal, the distribution of the total volume among the various source elements may otherwise vary. Manufacturing and operational circumstances and desired outcomes of the survey may dictate preferred ranges of source element volumes. Although each source subarray 221 should have like source elements 222 deployed at substantially equal distances from the forward-most source element 222-f, the specific distances may vary from that illustrated by TDQS source array 225. Manufacturing and operational circumstances and desired outcomes of the survey may dictate preferred positions of the source elements 222 in each source subarray 221. Although (i) the six source subarrays 221 should be deployed at three different depths, (ii) the middle of which being substantially halfway between the deepest and the shallowest, (iii) the depth of source subarray 221-1 being substantially equal to the depth of source subarray 221-4, (iv) the depth of source subarray 221-2 being substantially equal to the depth of source subarray 221-5, and (v) the depth of source subarray 221-3 being substantially equal to the depth of source subarray 221-6, the specific depths of each source subarray 221 may vary from that illustrated by TDQS source array 225. Manufacturing and operational circumstances and desired outcomes of the survey may dictate preferred ranges of depths of each source subarray 221. Although the crossline source separation (between adjacent source subarrays 221) should be substantially equal from one pair to the next, the distances from the midline may vary from those shown in TDQS source array 225. Manufacturing and operational circumstances and desired outcomes of the survey may dictate preferred ranges of distances from midline of each source subarray 221.

In comparison to dual-source setup 110 or triple-source setup 111, TDQS source array 225 may be more complex and/or costly for manufacturing, deployment, and operation. Nonetheless, a TDQS source array may provide greater crossline streamer separation and greater acquisition efficiency than either a dual-source setup or a triple-source setup. Alternatively, a TDQS source array may provide better spatial crossline sampling than a dual-source setup or a triple-source setup, and thereby provide images with improved spatial resolution.

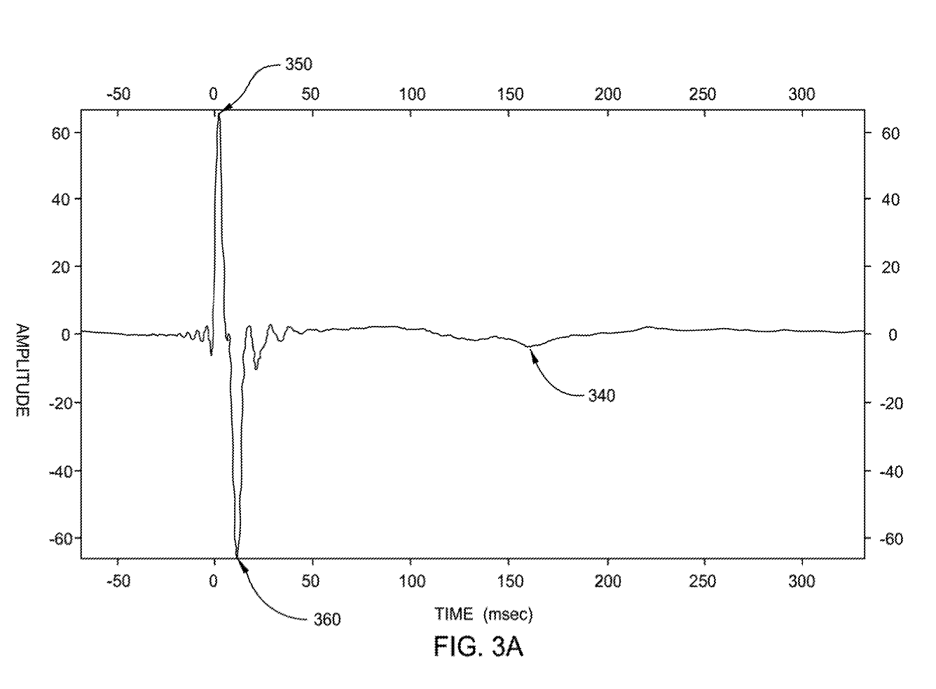

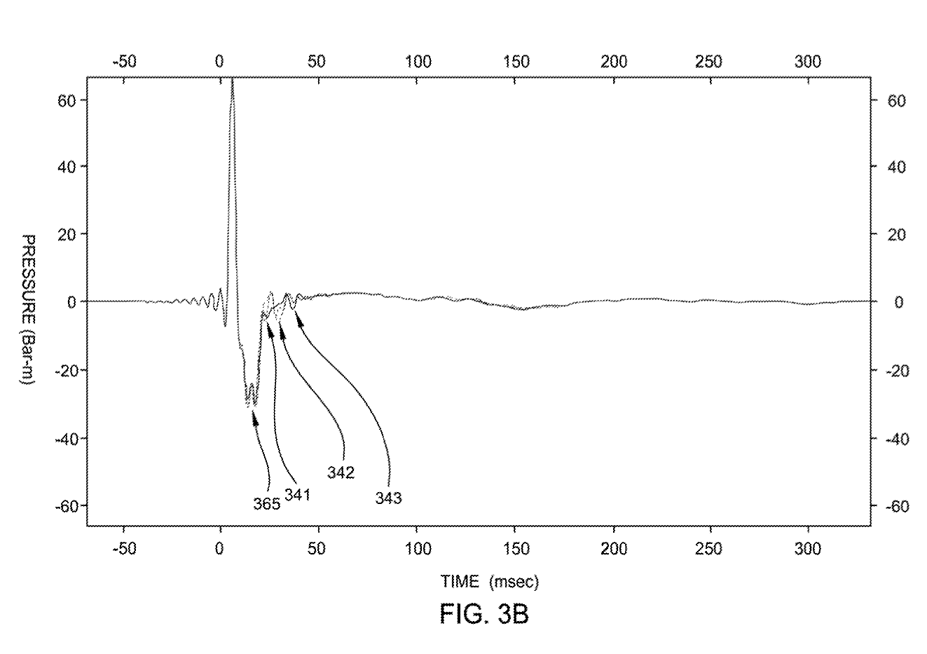

In some embodiments, a TDQS source array may be deployed and operated to improve data acquisition and/or processing. For example, techniques exist to remove “ghost” effects from conventional survey data during post-acquisition processing. A TDQS source array may be used to acquire data with minimal or no source ghost, thereby reducing post-acquisition processing costs, and reducing risks of noise introduction that accompanies many standard post-acquisition processing techniques. FIG. 3A illustrates an exemplary time series signal 340 from a conventional source array. The shot shows as a strong peak 350, while the source ghost shows as a strong nadir 360. FIG. 3B illustrates an exemplary pressure signal from a TDQS source array. The overall pressure signal includes separate pressure signals 341, 342, 343 from three different source subarrays. As before, the shot shows a strong peak 350. However there is now a series of less-strong nadirs 365, each representing a source ghost for a separate source subarray.

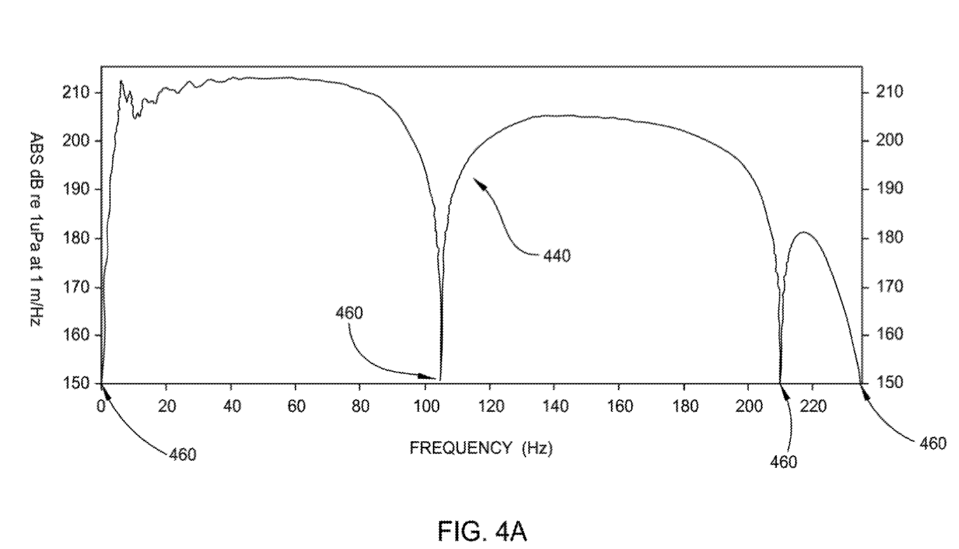

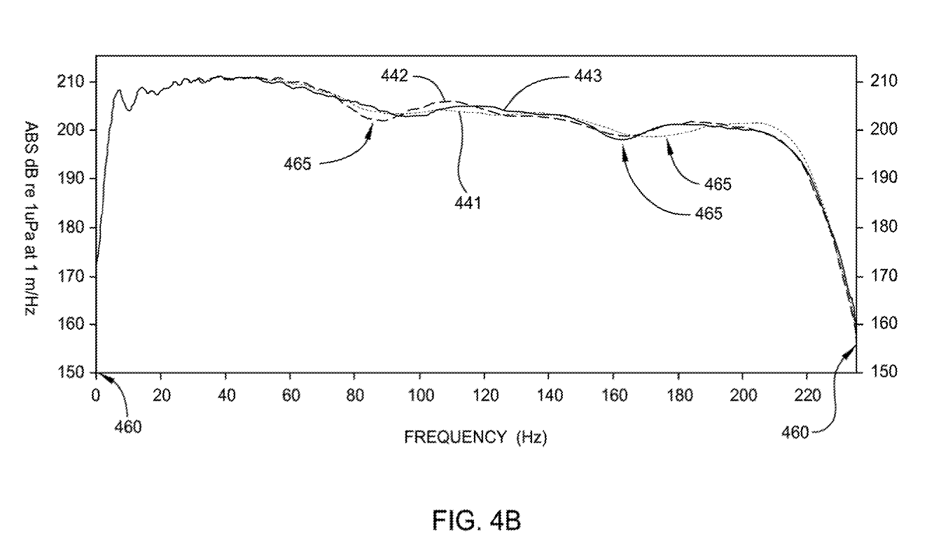

The reduction in source ghost by TDQS surveying can be further seen in FIGS. 4A-4B. FIG. 4A illustrates an exemplary amplitude spectrum 440 for a conventional source array. Source ghosts can be seen at strong nadirs 460 at about 0 Hz, 110 Hz, 215 Hz, and 240 Hz. FIG. 4B illustrates an exemplary amplitude spectrum 440 for a TDQS source array. Strong nadirs 460 can still be seen at about 0 Hz and about 240 Hz. However there is now a series of less-strong nadirs 465, each representing a source ghost for a separate source subarray. For example, amplitude spectrum 441 may have a less-strong nadir 465 at about 175 Hz, amplitude spectrum 442 may have a less-strong nadir 465 at about 85 Hz, and amplitude spectrum 443 may have a less-strong nadir 465 at about 165 Hz.

FIGS. 4A-4B also illustrate the broadband improvement of the TDQS source array amplitude spectrum. FIG. 4A illustrates an amplitude spectrum 440 from a conventional source. In contrast, FIG. 4B illustrates amplitude spectra 441, 442, 443 from a TDQS source. As would be understood by a person of ordinary skill in the art with the benefit of this disclosure, an improved broadband source signal—sustained amplitude over more and/or higher frequencies—may provide better analysis and/or imaging. Higher frequency source signals may better illuminate detailed fault outlines in the subsurface formation. Shallow features may be better identified with TDQS acquisition, while being essentially unrecoverable with conventional techniques. Moreover, high frequency data (e.g., about 100-125 Hz, or even about 125-150 Hz) may be directly measured with the use of TDQS source arrays. Conventionally, such high frequency data would typically require additional processing, which may introduce noise and can be costly and inefficient.

A TDQS survey may combine the benefits of a quad-source setup with a multi-level source to improve both crossline sampling (due to the quad-source setup) and also achieve a broadband frequency signal (due to the multi-level source). For example, a TDQS survey may include sequential actuation of the four seismic sources (e.g., seismic sources 220-A, 220-B, 220-C, 220-D) of the TDQS source array. Since each of the seismic sources of the TDQS source array includes three independent source subarrays at three different depths, each shot provides the broadband signal benefits of multi-level shooting. In some embodiments, actuation of the deeper sources is delayed for a time period to reduce the source ghost. In some embodiments, time delay may also be applied to align the primary signals of the source elements. In some embodiments, alignment of the primary signals may beneficially suppress the ghost signal.

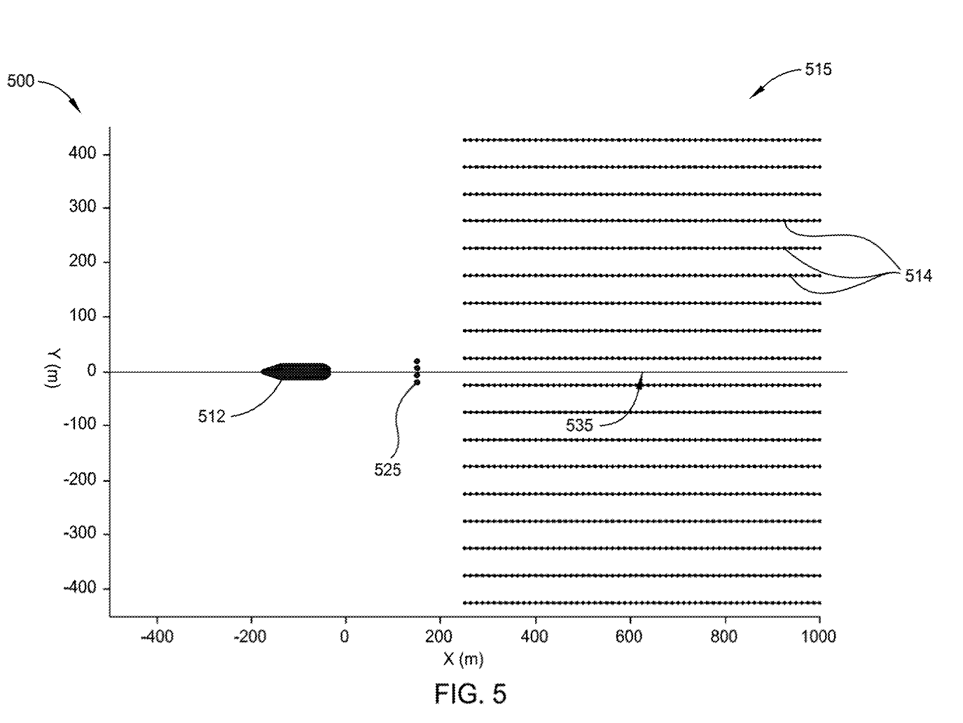

In some embodiments, a TDQS source array may be towed in conjunction with a streamer array. FIG. 5 illustrates an exemplary TDQS survey system 500 that includes a TDQS source array 525 and a streamer array 515, both towed by survey vessel 512. As illustrated, the streamer array 515 includes eighteen streamers 514 nominally aligned on either side of midline 535 at equal intervals (e.g., about 50 meters between adjacent streamers 514). The TDQS source array 525 is configured similarly to TDQS source array 225, having six independent source subarrays (not shown) at a crossline source separation of about 12.5 m. As illustrated, the TDQS survey system 500 has a crossline bin width of about 6.25 m. Operation of the TDQS survey system 500 includes a variety of navigational and source actuation inputs. For example, the shot point interval (i.e., the distance between sequential actuations of each of the seismic sources of the TDQS source array 525) may be determined by the speed of the survey vessel 512 and the timing between actuations. As another example, the sail line separation may be determined by the nominal path of the survey vessel 512 during a first pass across the survey area and the nominal path of the survey vessel 512 during a second pass across the survey area, wherein the survey vessel 512 turns about 180 degrees at the edge of the survey area between the first pass and the second pass. Operation of the TDQS survey system 500 so that the shot point interval is about 12.5 m and the sail line separation is about 450 m results in a fold of the survey of about 80. Therefore, the TDQS survey system 500 has an even fold distribution. In some embodiments, the TDQS survey system 500 may be operated to have a shot point interval of between about 10 m and about 50 m. In some embodiments, TDQS survey system 500 may be operated to have a shot point interval that remains substantially constant along a sail line and/or throughout the TDQS survey to provide more uniform recording. In some embodiments, TDQS source array 525 may have a wider crossline source separation. In some embodiments, the crossline streamer separation may be increased commensurate with the crossline source separation. It is currently believed that a wider crossline source separation will result in enhanced directionality for TDQS source array 525.

The methods and systems described herein may be used to manufacture a geophysical data product indicative of certain properties of a subterranean formation. The geophysical data product may include geophysical data such as pressure data, particle motion data, particle velocity data, particle acceleration data, and any seismic image that results from using the methods and systems described above. The geophysical data product may be stored on a non-transitory computer-readable medium as described above. The geophysical data product may be produced offshore (i.e., by equipment on the survey vessel) or onshore (i.e., at a computing facility on land) either within the United States or in another country. When the geophysical data product is produced offshore or in another country, it may be imported onshore to a data-storage facility in the United States. Once onshore in the United States, geophysical analysis may be performed on the geophysical data product.

While the foregoing is directed to embodiments of the present disclosure, other and further embodiments of the disclosure may be devised without departing from the basic scope thereof, and the scope thereof is determined by the claims that follow.

1. A seismic source array comprising:
four seismic sources, each comprising three independent source subarrays, wherein, for each seismic source:
each source subarray is configured to be towed at a different one of three selected depths,
each source subarray has a same total volume, and
each source subarray comprises a same number of source elements;
wherein the four seismic sources share the three independent source subarrays such that the seismic source array consists of six source subarrays.

2. The seismic source array of claim 1, wherein:
a first of the four seismic sources comprises a first, second, and third of the six source subarrays,
a second of the four seismic sources comprises a fourth, fifth, and sixth of the six source subarrays,
a third of the four seismic sources comprises the second, third, and fourth of the six source subarrays, and
a fourth of the four seismic sources comprises the third, fourth, and fifth of the six source subarrays.

3. The seismic source array of claim 1, wherein the six source subarrays are configured to be towed to have a same crossline source separation.

4. The seismic source array of claim 1, wherein a middle of the three selected depths is halfway between a deepest and a shallowest of the three selected depths.

5. The seismic source array of claim 1, wherein, for each of the six source subarrays, the source elements are disposed at seven different inline positions along a common source cable.

6. The seismic source array of claim 5, wherein two source elements are disposed at each of five of the seven different inline positions.

7. The seismic source array of claim 6, wherein one source element is disposed at each of the other two of the seven different inline positions.

8. The seismic source array of claim 6, wherein two of the source elements are designated as spare, and wherein the two spare source elements are disposed at two of the five of the seven different inline positions having two source elements.

9. The seismic source array of claim 1, wherein, for each of the six source subarrays, the source elements are configured to be towed at seven different inline positions.

10. The seismic source array of claim 1, wherein three of the six source subarrays are configured to be towed port of a midline, and another three of the six source subarrays are configured to be towed starboard of the midline.

11. A survey system comprising:
a survey vessel;
the seismic source array of claim 1; and
a streamer array, wherein the survey vessel is configured to tow the seismic source array and the streamer array.

12. A method of marine surveying comprising:
towing six source subarrays with a survey vessel; and
sequentially actuating four sets of three of the six source subarrays to generate a source signal with each actuation, wherein, for each of the four sets, the three of the six source subarrays:
are towed at three different selected depths,
have a same total volume, and
comprise a same number of source elements.

13. The method of claim 12, wherein:
a first of the four sets comprises a first, second, and third of the six source subarrays,
a second of the four sets comprises a fourth, fifth, and sixth of the six source subarrays,
a third of the four sets comprises the second, third, and fourth of the six source subarrays, and
a fourth of the four sets comprises the third, fourth, and fifth of the six source subarrays.

14. The method of claim 12, wherein the six source subarrays are towed with a same crossline source separation.

15. The method of claim 12, wherein a middle of the three different selected depths is halfway between a deepest and a shallowest of the three different selected depths.

16. The method of claim 12, wherein, for each of the six source subarrays, the source elements are towed at seven different inline positions.

17. The method of claim 16, wherein two source elements are disposed at each of five of the seven different inline positions.

18. The method of claim 17, wherein one source element is disposed at each of the other two of the seven different inline positions.

19. The method of claim 17, wherein two of the source elements are designated as spare, and wherein the two spare source elements are disposed at two of the five of the sever different inline positions having two source elements.

20. The method of claim 12, wherein three of the six source subarrays are towed port of a midline, and another three of the six source subarrays are towed starboard of the midline.

21. The method of claim 12, further comprising:
towing a streamer array with the survey vessel; and
acquiring data with receivers on the streamer array.
